(19) United States
(12) Patent Application Publication
(10) Pub. No.: US 2025/0336183 A1
(43) Pub. Date: Oct. 30, 2025

(54) METHOD AND APPARATUS WITH IMAGE CLASSIFICATION AI MODEL

(71) Applicant: Samsung Electronics Co., Ltd., Suwon-si (KR)

(72) Inventors: Byungjai KIM, Suwon-si (KR); Sungjoo SUH, Suwon-si (KR); Wissam BADDAR, Suwon-si (KR); Huijin LEE, Suwon-si (KR); Seungju HAN, Suwon-si (KR)

(73) Assignee: Samsung Electronics Co., Ltd., Suwon-si (KR)

(21) Appl. No.: 19/195,359

(22) Filed: Apr. 30, 2025

(30) Foreign Application Priority Data
Apr. 30, 2024 (KR) 10-2024-0057679
Aug. 2, 2024 (KR) 10-2024-0102958
Apr. 29, 2025 (KR) 10-2025-0056721

(51) Int. Cl. G06V 10/764; G06T 7/00; G06V 10/77; G06V 10/82

(52) U.S. Cl. CPC G06V 10/764; G06T 7/0004; G06V 10/7715; G06V 10/82; G06T 2207/20081; G06T 2207/20084; G06T 2207/30148

(57) ABSTRACT

A method for determining a class of an image includes: receiving a first prediction result for the class from a first classifier and a second prediction result for the class from a second classifier, updating an artificial intelligence (AI) model of the first classifier based on the first prediction result and the second prediction result, and inferring the class of the image using the updated AI model are provided.

### CROSS-REFERENCE TO RELATED APPLICATION

This application claims priority to and the benefit under 35 USC § 119(a) of Korean Patent Application No. 10-2024-0057679 filed in the Korean Intellectual Property Office on Apr. 30, 2024, Korean Patent Application No. 10-2024-0102958 filed in the Korean Intellectual Property Office on Aug. 2, 2024, and Korean Patent Application No. 10-2025-0056721 filed in the Korean Intellectual Property Office on Apr. 29, 2025, the entire contents of which are incorporated herein by reference.

### BACKGROUND

### 1. Field

This disclosure relates to a method and device with an artificial intelligence model for image classification.

### 2. Related Art

Test-time adaptation (TTA) is a technique for improving classification performance of an artificial intelligence (AI) image classifier model in a target domain that is different from a source domain of images used in training of the AI classifier model. Generally, for images in a target domain other than the source domain (domain-shifted images), an adaptation procedure may be performed to adapt the AI classifier model (which has been trained on the images in the source domain). Once the AI classifier model's parameters have been updated through the adaptation procedure, the model may perform the classification on images in the target domain.

If the domain of images being classified by the AI classifier model change to the target domain, since the characteristics of the image in the target domain are different from the characteristics of the images in the source domain, before the AI classifier model (as trained on images in the source domain) may classify images in the target domain, test-time adaptation may be performed to enable classification in the target domain.

### SUMMARY

In a general aspect, a method for determining a class of an image includes: receiving a first prediction result for the class from a first classifier and a second prediction result for the class from a second classifier; updating a first artificial intelligence (AI) model of the first classifier based on the first prediction result and the second prediction result; and inferring the class using the updated first AI model of the first classifier.

The receiving the first prediction result for the class from the first classifier and the second prediction result for the class from the second classifier may include: updating second parameters of a second AI model of the second classifier using first parameters of the first AI model of the first classifier; and receiving the second prediction result for the class from the updated second classifier.

The updating second parameters of the second AI model of the second classifier using the first parameters of the first AI model of the first classifier may include updating the second parameters of the second AI model with a weight-space ensemble operation performed on the first parameters and the second parameters.

The weight-space ensemble operation may include calculating an exponential moving average (EMA) of the first parameters and the second parameters.

The receiving the first prediction result for the class from the first classifier and the second prediction result for the class from the second classifier may include: performing a dropout on a feature vector of the image generated by an encoder in the first AI model; and generating the first prediction result from the dropped-out feature vector.

The receiving the first prediction result for the class from the first classifier and the second prediction result for the class from the second classifier may include: performing a dropout on a node or a connection within an encoder in the first AI model; and extracting a feature vector of the image using the encoder to which the dropout has been applied and generating the first prediction result from the feature vector using the first AI model.

The receiving the first prediction result for the class from the first classifier and the second prediction result for the class from the second classifier may include: performing a dropout on a weight value matrix of a linear layer in the first AI model; and generating the first prediction result based on calculation between the weight value matrix to which the dropout has been applied and a feature vector of the image.

The updating the first classifier based on the first prediction result and the second prediction result may include: calculating an objective function for updating the first AI model based on cross entropy of the first prediction result and the second prediction result.

The objective function may be determined based on a weighted sum of information entropy of the first prediction result and a probabilistic distance between the first prediction result and the second prediction result.

The first AI model and a second AI model of the second classifier may be pre-trained based on images belonging to domains to which the image does not belong.

In another general aspect, an apparatus for determining a class of an image includes one or more processors and a memory, wherein the memory stores instructions configured to cause the one or more processors to perform a process, and the process includes: obtaining a first classification probability distribution for the class using a first artificial intelligence (AI) model; obtaining a second classification probability distribution for the class using a second AI model; updating the first AI model based on the first classification probability distribution and the second classification probability distribution; and inferring the class using the updated first AI model.

The obtaining the first classification probability distribution for the class using the first AI model may include: performing a dropout on a feature vector of the image generated by an encoder in the first AI model; and obtaining the first classification probability distribution from the dropped-out feature vector

The obtaining the first classification probability distribution for the class using the first AI model may include: performing a dropout on nodes or connections within an encoder in the AI model; and extracting a feature vector of the image using the encoder to which the dropout has been applied; and obtaining the first classification probability distribution from the feature vector.

The obtaining the first classification probability distribution for the class using the first AI model may include: performing a dropout on a weight value matrix of a linear layer in the first AI model; and obtaining the first classification probability distribution based on the weight value matrix to which the dropout has been applied and a feature vector of the image.

The obtaining the second classification probability distribution for the class using the second AI model may include: updating second parameters of the second AI model using first parameters of the first AI model; and obtaining the second classification probability distribution for the class using the second AI model having the updated second parameters.

The updating the second parameters of the second AI model using first parameters of the first AI model may include: updating the second parameters of the second AI model with an exponential moving average (EMA) of the first parameters of the first AI model and the second parameters of the second AI model.

The updating the first AI model based on the first classification probability distribution and the second classification probability distribution may include: calculating an objective function for updating the first AI model based on a weighted sum of information entropy of the first classification probability distribution and Kullback-Leibler (KL) divergences of the first classification probability distribution and the second classification probability distribution.

The updating the first AI model based on the first classification probability distribution and the second classification probability distribution may include: calculating an objective function for updating the first AI model based on a weighted sum of cross entropy between the first classification probability distribution and the second classification probability distribution and divergences of the first classification probability distribution for a vector whose elements are all 1.

In another general aspect, an image classification system includes: an inspection equipment configured to obtain a test image for inspection of semiconductors; and an image classifier configured to perform a test-time adaptation on one or more AI models and perform inference on the test image to predict a class of the test image.

In the test-time adaptation, the image classifier may be further configured to perform a large dropout for a first AI model of the one or more AI models, update second parameters of a second AI model of the one or more AI models using first parameters of the first AI model; and update the first AI model by determining an objective function based on a first classification probability distribution obtained from the first AI model on which the large dropout has been performed and a second classification probability distribution obtained from the updated second AI model.

Other features and aspects will be apparent from the following detailed description, the drawings, and the claims.

### BRIEF DESCRIPTION OF THE DRAWINGS

FIG. 1 illustrates an image classifier according to one or more embodiments.

FIG. 2 illustrates an image classification method according to one or more embodiments.

FIG. 3 illustrates a first classifier according to one or more embodiments.

FIG. 4 illustrates a class prediction method by a first classifier according to one or more embodiments.

FIG. 5 illustrates a second classifier according to one or more embodiments.

FIG. 6 illustrates a class prediction method by a second classifier according to one or more embodiments.

FIG. 7 illustrates an image classification system for a semiconductor manufacturing process according to one or more embodiments.

FIG. 8 illustrates different images of a training domain and a test domain according to one or more embodiments.

FIG. 9 illustrates an artificial neural system according to one or more embodiments.

FIG. 10 illustrates an image classifier according to another embodiment.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

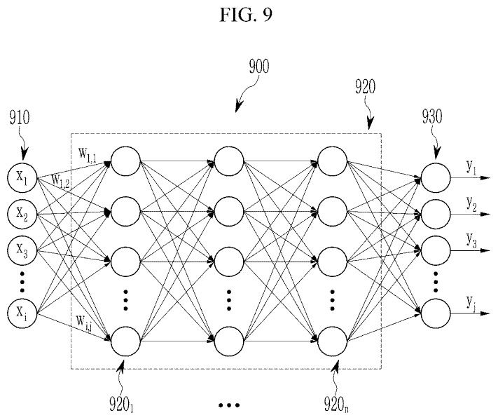

An artificial intelligence (AI) model may learn at least one task, and may be implemented as a computer program in the form of instructions executed by a processor. The task that the AI model learns may be a type of task that is to be solved through machine learning or a type of task that is to be executed through machine learning. The AI model may be implemented as a computer program executed on a computing apparatus, may be downloaded through a network, or may be sold as a product. Alternatively, the AI model may be accessed over a network, e.g., as a network service, by a variety of devices. A neural network example of an AI model is shown in FIG. 9.

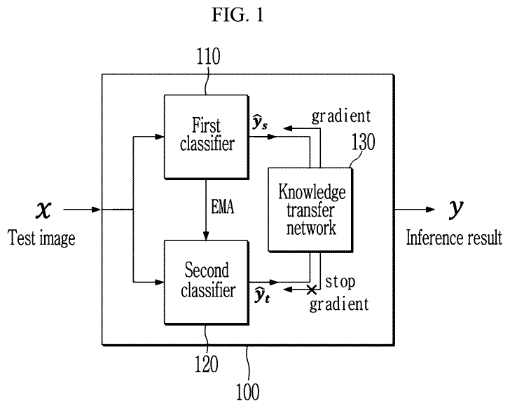

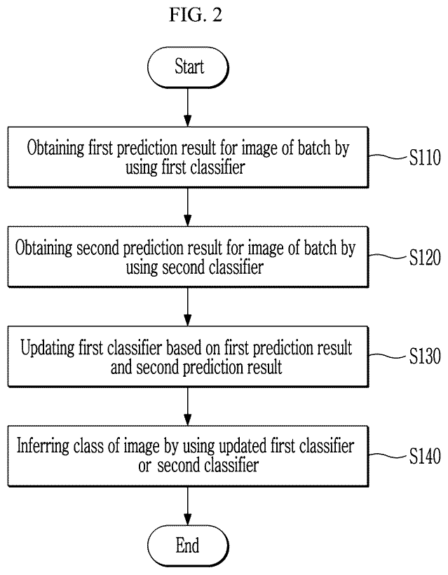

FIG. 1 illustrates an image classifier 100 according to one or more embodiments. FIG. 2 illustrates an image classification method according to one or more embodiments.

In some embodiments, the image classifier 100 may perform a test-time adaptation on a test image to determine a class of the test image and classify the test image into one class. The image classifier 100 according to one or more embodiments may perform the test-time adaptation for the test image to update the image classifier 110 in order to infer the class of an image in a domain (test domain) different from a training domain and the image classifier 110 updated through the test-time adaptation may determine the class of the test image.

Referring to FIG. 1, the image classifier 100 may include a first classifier 110, a second classifier 120, and a knowledge transfer network 130. The image classifier 100 may perform the test-time adaptation on the test image using the first classifier 110 and the second classifier 120 and infer the class of the test image.

In some embodiments, the first classifier 110 and the second classifier 120 may be pre-trained AI models based on images belonging to domains that are different than a domain of the test image. For example, the image classifier 100 may perform a fine-tuning on the first classifier 110 and the second classifier 120 through the test-time adaptation, and then determine the class of the test image using the tuned first classifier 110 or the tuned second classifier 120. Alternatively, the first classifier 110 and the second classifier 120 may use AI models pre-trained based on images belonging to the different domains than the domain of the test image. For example, the image classifier 100 may perform the fine-tuning on a first AI model run by the first classifier 110 and on a second AI model run by the second classifier 120 through the test-time adaptation. The class of the test image may be determined by the first classifier 110 using the first AI model or the second classifier 120 using the second AI model.

In some embodiments, the test-time adaptation of the image classifier 100 may be performed for a batch. The image classifier 100 may update parameters for one batch, infer based on the updated parameters. This process may be repeated for a next batch. That is, the image classifier 100 may update parameters for the next batch and perform inference based on the thus-updated parameters. For example, the image classifier 100 may make an expectation (inference performed during test time adaptation) on the test image in each batch to update parameters, and then perform inference on the test image in the same batch using the updated parameters.

In some embodiments, the first classifier 110 may output a classification probability distribution ŷₛ for the class of the test image x in the batch as a prediction result (probability distributions are discussed below). The parameters (first parameters) used when the inference is performed by the first classifier 110 may be transmitted to the second classifier 120 for updating parameters (second parameters) of the second classifier 120.

In some embodiments, when the first classifier 110 performs inference on the test image, the first classifier 110 may (i) disable some nodes (or neurons) and/or connections within an AI model run by the first classifier 110 through a large dropout, and/or may (ii) cut off some of the outputs of the layers within the AI model run by the first classifier 110. For example, the large dropout (alternatively, a large-scale dropout, a dropout with high rate, etc.) may be performed on outputs (e.g., a feature vector of the test image) of an encoder of the first classifier 110 and a linearization operation may be performed on the remaining outputs of the encoder after the large dropout has been performed.

In some embodiments, the large dropout may involve an operation when there are a large number of nodes or edges to be disabled or blocked, or when the outputs of the encoder have a high probability of being disabled or blocked. For example, the probability p of the large dropout may be a real number between 0.7 and 0.9.

Alternatively, the large dropout may be performed on some nodes or connections within the encoder of the first classifier 110, and a feature vector of the test image may be output using the encoder to which the large dropout has been applied. Alternatively, the large dropout may be performed on some weight values of a weight value matrix of the linear layer of the first classifier 110, and the linear layer may generate a classification probability distribution from the feature vector (of the test image) through an operation using the weight value matrix on which the large dropout has been performed.

In some embodiments, the second classifier 120 may update the previously-mentioned second parameters of an AI model run by the second classifier 120 based on the first parameters of the first classifier 110. Then, the second classifier 120 may, using the updated second parameters, output a classification probability distribution ŷₜ for the class of the test image x in the batch as the prediction result.

In some embodiments, the second parameters of the second AI model run by the second classifier 120 may be updated with a weight-space ensemble of the first parameters of the first AI model run by the first classifier 110 and the pre-update second parameters of the second AI model run by the second classifier 120. The second classifier 120 may predict the classification probability distribution for the class of the test image using the updated second parameters. For example, the weight-space ensemble may be performed by an exponential moving average EMA of the parameter of the first AI model and the parameter of the second AI model.

In some embodiments, when the second parameters of the second AI model run by the second classifier 120 are updated by an ensemble of the first parameters of the first AI model and the second parameters of the second AI model, the first classifier 110 may operate as an adapter network and the second classifier 120 may operate as an ensemble network in which the first parameters of the first AI model run by the first classifier 110 have converged.

In some embodiments, the knowledge transfer network 130 may update the first AI model based on the classification probability distribution ŷₛ obtained from the first classifier 110 and the classification probability distribution, obtained from the second classifier 120. Here, a gradient backpropagated to the first AI model may be used to update the first classifier 110, but may not be propagated to the second AI model. That is, in some embodiments the second classifier 120 is not updated by the knowledge transfer network 130.

In some embodiments, the knowledge transfer network 130 may compute an objective function based on a cross entropy of the classification probability distribution obtained from the first classifier 110 and the classification probability distribution obtained from the second classifier 120. In some embodiments, the objective function may be determined based on a weighted sum of an information entropy of the classification probability distribution obtained from the first classifier 110 and a probabilistic distance between the classification probability distribution obtained from the first classifier 110 and the classification probability distribution obtained from the second classifier 120.

Regarding the prediction result of the second classifier 120 being transmitted to the first classifier 110 and used to update the first classifier 110, the first classifier 110 may operate as a student classifier for the second classifier 120 and the second classifier 120 may operate as a teacher classifier for the first classifier 110.

Referring to FIG. 2, the image classifier 100 may obtain a first prediction result for the class of the test image included in the batch by using the first AI model of the first classifier 110 (S110).

In some embodiments, when the first classifier 110 predicts the classification probability distribution for the class of the test image, the image classifier 100 may perform the large dropout on the first classifier 110 (such that the inference by the image classifier 100 is performed according to the large dropout). The large dropout may be performed in the encoder of the first classifier 110, or in the linear layer of the first classifier 110, or in both the encoder and linear layer of the first classifier 110. Alternatively, the large dropout may be performed on an intermediate result (e.g., a feature map corresponding to the test image, the feature vector, etc.) output from a specific layer within the first classifier 110.

In some embodiments, a large number of nodes or connections in the first AI model of the first classifier 110 may be deactivated by the large dropout, and the relatively few activated nodes or connections in the first AI model may be used to predict the class of the test image. Alternatively, some of the outputs of the specific layer in the first AI model may be invalidated through the large dropout, and the remaining portion of the output that has not been invalidated may be used to predict the class of the test image.

According to some embodiments, as the fine-tuning is performed through the large dropout on the first classifier 110, various combinations of the characteristics of the pre-trained models may be possible, and a representation that is robust to a shift in the classification probability distribution due to changes in the domain of the images in the batch may be generated.

Referring to FIG. 2, the image classifier 100 may obtain a second prediction result for the class of the test image included in the batch S120 by using the second AI model of the second classifier 120. In some embodiments, the image classifier 100 may update the second parameters of the second AI model run by the second classifier 120 through the weight-space ensemble between the first parameters of the first AI model and the second parameters of the second AI model, and obtain the second prediction result for the class of the test image using the second AI model of the second classifier 120 with the updated second parameters. The weight-space ensemble may be executed by the exponential moving average (EMA) of both the first parameters of the first AI model and the second parameters of the second AI model.

In some embodiments, the first classifier 110 and the second classifier 120 may process the test images in the batch in parallel to generate prediction results for the test images. The first classifier 110 may process the test images in parallel to generate the prediction results for the test images, and the first parameters used by the first classifier 110 to generate the prediction results may be transmitted to the second classifier 120 and used for the weight-space ensemble between the first classifier 110 and the second classifier 120.

For example, a parameter set θₙ used to generate the prediction result for the test image among the test images by the first classifier 110 may be transmitted to the second classifier 120, or an average value θ_{n_avg} of the first parameters included in the parameter set θₙ may be transmitted to the second classifier 120.

In some embodiments, as the second classifier 120 is updated through the weight-space ensemble with the first classifier 110, the test-time adaptation may be with a much smaller number of operations than when multiple models are ensembled, resulting in a richer expressiveness of the ensemble.

Referring to FIG. 2, the knowledge transfer network 130 of the image classifier 100 may update the first classifier 110 based on the first prediction result obtained from the first classifier 110 and the second prediction result obtained from the second classifier 120 (S130).

In some embodiments, the knowledge transfer network 130 may compute the objective function for updating the first AI model run by the first classifier 110 based on the cross entropy of the first classification probability distribution obtained by the first classifier 110 and the second classification probability distribution obtained by the second classifier 120.

The gradient determined from the computation of the objective function may be backpropagated to the first classifier 110, but not to the second classifier 120. That is, while the update of the first AI model is performed by the knowledge transfer network 130, the update of the second classifier 120 is not performed by the knowledge transfer network 130. However, update of the second classifier 120 may be performed through the weight-space ensemble between the first parameters of the first AI model and the second parameters of the second AI model.

In some embodiments, when the first classification probability distributions and the second classification probability distributions respectively corresponding to the test images are obtained, the knowledge transfer network 130 may calculate the objective functions using the first classification probability distribution and the second classification probability distributions, and the average value of the calculation results of the objective functions may be fed back to the first classifier 110 as the gradient.

In some embodiments, the knowledge transfer network 130 may calculate the objective function for the update of the first AI model based on the information entropy of the first classification probability distribution ŷₛ obtained from the first classifier 110 and the second classification probability distribution ŷₜ obtained from the second classifier 120.

Equation 1 represents the objective function, as calculated from a sum of the information entropy of the first classification probability distribution ŷₛ and a Kullback-Leibler (KL) divergence of the first classification probability distribution ŷₛ and the second classification probability distribution ŷₜ.

$$L ( {\hat{y}}_{s} , {\hat{y}}_{t} ) ≡ H ( {\hat{y}}_{s} ) + {D}_{K L} ( \hat{{y}_{s}} \text{\vert \vert} {\hat{y}}_{t} ) \qquad Equation 1$$

The objective function of Equation 1 expresses cross entropy between the first classification probability distribution ŷₛ and the second classification probability distribution ŷₜ, which reduces the uncertainty of the first classification probability distribution ŷₛ by fitting the first classification probability distribution ŷₛ to the second classification probability distribution, which is the ensemble output. The Kullback-Leibler (KL) divergence of Equation 1 is an example representing a probabilistic distance between the first classification probability distribution ŷₛ and the second classification probability distribution ŷₜ.

The objective function of Equation 1 may be expressed as Equation 2 below in the form of the weighted sum of the information entropy of the first classification probability distribution ŷₛ and the Kullback-Leibler (KL) divergence of the first classification probability distribution ŷₛ and the second classification probability distribution ŷₜ using weighting coefficients α and β.

$$L ( {\hat{y}}_{s} , {\hat{y}}_{t} ) = α H ( {\hat{y}}_{s} ) + β {D}_{K L} ( {\hat{y}}_{s} \text{\vert \vert} {\hat{y}}_{t} ) \qquad Equation 2$$

In Equation 2, the information entropy of the first classification probability distribution ŷₛ obtained from the first classifier 110 may be supplemented by the Kullback-Leibler (KL) divergence between the first classification probability distribution ŷₛ and the second classification probability distribution ŷₜ, and knowledge distillation may thereby be performed between the first classifier 110 and the second classifier 120.

Since the Kullback-Leibler (KL) divergence is as in Equation 3, the objective function of Equation 2 may be rearranged as in Equation 4.

$${D}_{K L} ( {\hat{y}}_{s} \text{\vert \vert} {\hat{y}}_{t} ) ≡ H ( {\hat{y}}_{s} , {\hat{y}}_{t} ) - H ( {\hat{y}}_{s} ) \qquad Equation 3$$

$$L ( {\hat{y}}_{s} , {\hat{y}}_{t} ) = β H ( {\hat{y}}_{s} , {\hat{y}}_{t} ) - ( β - α ) H ( {\hat{y}}_{s} ) \qquad Equation 4$$

Here, the information entropy of the first classification probability distribution ŷₛ may be expressed in a divergent form using a vector 1_{C} with all elements as 1

$$- H ( {\hat{y}}_{s} ) = {D}_{K L} ( {\hat{y}}_{s} \text{\vert \vert} {1}_{C} ) \qquad Equation 5$$

By rearranging Equation 4 using Equation 5, the generalized objective function may be expressed as Equation 6.

$${L}_{g e n} ( {\hat{y}}_{s} , {\hat{y}}_{t} ) = H ( {\hat{y}}_{s} , {\hat{y}}_{t} ) + λ {D}_{K L} ( {\hat{y}}_{s} \text{\vert \vert} {1}_{C} ) \qquad Equation 6$$

In Equation 6, 2 is a simplified coefficient of the weight coefficients α and β and is as shown in Equation 7 below.

$$λ = \frac{β - α}{β} \qquad Equation 7$$

Referring to Equation 6, the knowledge transfer network 130 may calculate the objective function through the weighted sum of the cross entropy between the first classification probability distribution ŷₛ and the second classification probability distribution ŷₜ, and the Kullback-Leibler (KL) divergence for the vector 1_{C} with all elements of the first classification probability distribution ŷₛ as 1.

Depending on the sign λ of Equations 6 and 7, the objective function may function differently. When λ>0 (β>α), the divergence (a second term on the right side of Equation 6) of the first classification probability distribution ŷₛ for the vector 1_{C} (a vector whose elements are all 1) may function as a regularization that smooths the first classification probability distribution ŷₛ. When the first classification probability distribution is smoothed, the distribution becomes wider overall and the chance of a model collapse may be reduced.

Also, when λ<0 (β<α), the divergence of the first classification probability distribution ŷₛ for the vector (of which the elements are all 1) may sharpen the first classification probability distribution ŷₛ and reduce the randomness of the prediction. In some embodiments, the image classifier 100 may improve classification accuracy without model collapse even in the case of the negative value λ through the large dropout for the first classifier 110 and the weight-space ensemble for the second classifier 120, which has been proven experimentally.

Meanwhile, when λ=0 (β=α), Equation 6 may be converted to the form of Equation 1 through Equation 3 (Equation 8).

$$\begin{matrix}{L}_{g e n} ( {\hat{y}}_{s} , {\hat{y}}_{t} ) = H ( {\hat{y}}_{s} , {\hat{y}}_{t} ) + 0 \\ = H ( {\hat{y}}_{s} ) + {D}_{K L} ( {\hat{y}}_{s} \text{\vert \vert} {\hat{y}}_{t} )\end{matrix} \qquad Equation 8$$

Referring to FIG. 2, the image classifier 100 may infer the class of the test image in the batch S140 using the updated first AI model of the first classifier 110 or the updated second AI model of the second classifier 120 (S140).

In some embodiments, the classification performance of the first classifier 110 and the second classifier 120 of the image classifier 100 may be converged to become similar through the test-time adaptation for the image in the batch. Therefore, the image classifier 100 may infer the class of the image in the batch using the first classifier 110 or second classifier 120 updated after the test-time adaptation is performed on the image in that batch.

As described above, the image classifier 100 according to one or more embodiments may perform the test-time adaptation with high operation efficiency through the large dropout and the weight-space ensemble. Therefore, the image classifier 100 according to one or more embodiments may perform the test-time adaptation with a small number of calculations during a short calculation time, and may accurately predict the class even for a domain-shifted image through the large dropout and the weight-space ensemble. Accordingly, the calculational burden of the AI model may be reduced, which may reduce the power consumption of the device operating the AI model and greatly improve the sustainability of the AI model.

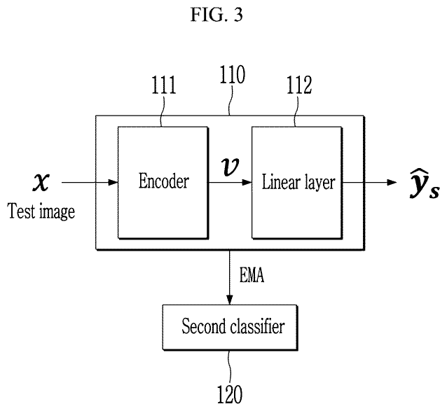

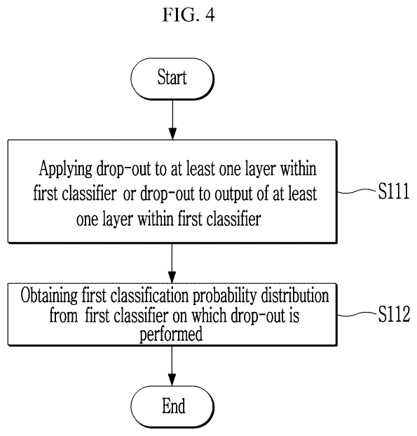

FIG. 3 illustrates the first classifier 110 according to one or more embodiments. FIG. 4 illustrates a class prediction method by the first classifier 110 according to one or more embodiments.

In some embodiments, when the first classifier 110 predicts the class of the test image, the large dropout may be performed. The large dropout may be performed on the encoder (e.g., a backbone of a pre-trained image network) 111 of the first classifier 110, on a linear layer 112, and/or on the feature vector output from the encoder 111. The large dropout may be performed by Bernoulli trial with a probability p for each target object (Bernoulli (p)). The probability p of the large dropout may be a hyperparameter and may have a value, for example, between 0.7 and 0.9.

In some embodiments, as the relatively small number of the first parameters randomly selected through the large dropout are used in the feedforward of the first classifier 110, when the test-time adaptation is performed on multiple batches, the various combinations of parameters may be selected, which may increase diversity of the representation that the first classifier 110 learns. Increasing the representation diversity may contribute to improving the performance of the image classifier 100 on the batch including the images from the various domains.

Referring to FIG. 4, the dropout may be applied to at least one component (e.g., the encoder, the linear layer, etc.) or layer within the first AI model of the first classifier 110, or the dropout may be applied to the output of at least one layer within the first AI model of the first classifier 110 (S111). For example, when a convolutional neural network (CNN) is used by the first classifier 110, the dropout may be applied to a convolution layer and/or a pooling layer of the CNN, or the dropout may be applied to the output of the convolution layer and/or the pooling layer.

When the large dropout is performed on the encoder 111 in the first AI model, some nodes or connections within the encoder 111 may be disabled. When the large dropout is performed on the linear layer 112 in the first AI model of the first classifier 110, the weight values randomly selected in the weight value matrix of the linear layer 112 may be disabled as 0. The deactivation of each node, edge, and/or weight value may be determined by the probability p of the Bernoulli trial. For example, when the probability p of the Bernoulli trial is 0.7, the nodes, edges, and/or weight values in the first AI model of the first classifier 110 may be disabled with the probability of 70%, respectively.

In some embodiments, when large dropout is performed on the feature vector v of the test image that is output by the encoder (111, or a penultimate layer) in the first AI model, the large dropout performed as follows.

In some embodiments, the dropped-out feature vector \tilde{v} may be determined by a calculation between the probability variable r of the Bernoulli trial of the probability p (r˜Bernoulli (p)) and the feature vector v. Equation 9 represents the dropped-out feature vector \tilde{v}.

$$\tilde{v} = r * ν \qquad Equation 9$$

In Equation 9, each element of the probability variable r may be independently determined as 1 or 0 by the Bernoulli trial with the probability p. In Equation 9, the symbol * represents an element-wise multiplication of two vectors.

In some embodiments, the linear layer 112 may predict the classification probability distribution ŷₛ using the dropped-out feature vector. The equation 10 represents the classification probability distribution ŷₛ obtained from the first classifier 110.

$${\hat{y}}_{s} = W \times \tilde{v} + b \qquad Equation 10$$

In Equation 10, W is the weight value matrix of the weight values used in the linear layer 112, and b is a bias vector of biases used in the linear layer 112. In some embodiments, the first classification probability distribution generated by the first classifier 110 may be used to evaluate and train the image classifier 100.

Referring to FIG. 4, the image classifier 100 may obtain the first classification probability distribution for the class of the test image as the prediction result from the first classifier 110 on which the dropout is performed (S112).

As described above, by performing the large dropout on the first classifier 110, the model diversity of the first AI model run by the first classifier 110 may be improved.

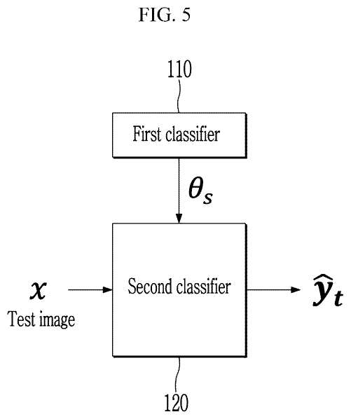

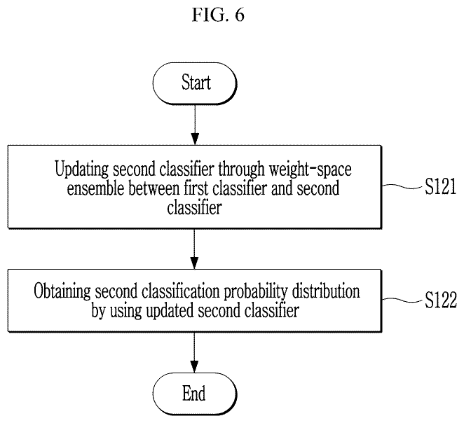

FIG. 5 illustrates a second classifier according to one or more embodiments. FIG. 6 illustrates a class prediction method by a second classifier according to one or more embodiments.

Referring to FIG. 5 and FIG. 6, the image classifier 100 may update the second classifier 120 through the weight-space ensemble between the first AI model and the second AI model (S121).

In some embodiments, the weight-space ensemble between the first AI model and the second AI model may be implemented as the exponential moving average (EMA) of the first parameters of the first AI model run by the first classifier 110 and the second parameters of the second AI model run by the second classifier 120. Equation 11 represents the second parameters of the second AI model updated by the exponential moving average of the first parameters of the first AI model and the second parameters of the second AI model.

$${θ}_{t} ← m {θ}_{t} + ( 1 - m ) {θ}_{s} \qquad Equation 11$$

In Equation 11, θₛ is the first parameters of the first AI model, and θₜ is the second parameters of the second AI model. m is a momentum of the exponential moving average, may be a value larger than 0 and less than 1, and is a hyperparameter.

In some embodiments, before the test-time adaptation for the first classifier 110 is sufficiently performed, small momentum may cause model collapse of the second classifier 120 because the reliability of the first parameters is low. However, small momentum greatly enhances the effect of the weight-space ensemble by actively updating the second parameters of the second AI model toward the first parameters. Large momentum may minimize sudden model changes and ensure an optimization stability, but has a drawback of increasing a computational complexity. In some embodiments, the image classifier 100 may perform the weight-space ensemble using relatively small momentum, thereby reducing the computational complexity of the model ensemble.

Next, the image classifier 100 may obtain the second classification probability distribution ŷₛ for the class of the test image by using the second classifier 120 as updated through the weight-space ensemble (S122).

In some embodiments, m of Equation 11 may be determined based on a difference between the first classification probability distribution ŷₛ generated by the first classifier 110 and the second classification probability distribution ŷₜ generated by the second classifier 110. Here, m used to adaptively perform weight-space ensemble based on the outputs of the first classifier 110 and the second classifier 120 may be called adaptive momentum. The equation 12 represents an example of m.

$$m = {m}_{0} \cdot {e}^{- {L}_{rkl} / τ} \qquad Equation 12$$

In Equation 12, m₀ is an initial constant of the adaptive momentum and t is another constant. Lᵣₖₗ on the right side of Equation 12 is the Kullback-Leibler divergence (KL divergence) of the outputs of the first classifier 110 and the second classifier 120, as shown in Equation 13 below.

$${L}_{rkl} = K L ( {\hat{y}}_{s} , {\hat{y}}_{t} ) \qquad Equation 13$$

That is, referring to Equations 12 and 13, the adaptive momentum m decreases as Lᵣₖₗ increases, so that the effect of the weight-space ensemble can be made greater as the difference between the outputs of the first classifier 110 and the second classifier 120 increases.

As explained above, as the second AI model run by the second classifier 120 is updated through the weight-space ensemble with the first parameters from the first classifier 110, the test-time adaptation of the second classifier 120 may be performed with a much smaller number of calculations compared to when multiple models are ensembled, thereby enabling the richer expression of the ensemble.

In some embodiments, the second classification probability distribution ŷₜ from the second classifier 120 may be biased by the bias vector. That is, to compensate for the bias during the knowledge transfer of the knowledge transfer network 130, the second classification probability distribution ŷₜ from the second classifier 120 may be centralized as in Equation 14 below.

$${\hat{y}}_{t}^{′} = {\hat{y}}_{t} - c \qquad Equation 14$$

In Equation 14, the initial value of the bias vector c may be set as 0 and updated to the exponential moving average of a first-order batch statistics of ŷₜ. In the calculation of the objective function of Equations 1 to 8, the centralized second classification probability distribution ŷₜ′ from the second classifier 120 may be used.

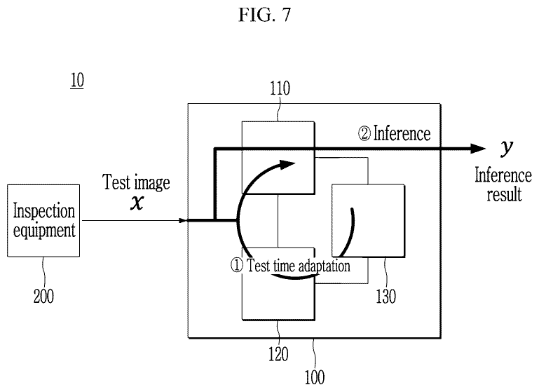

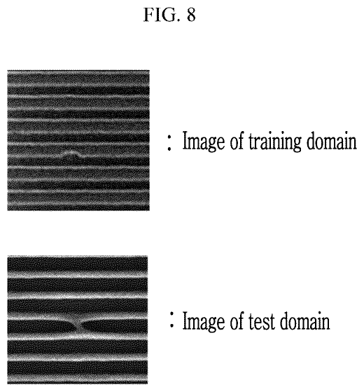

FIG. 7 illustrates an image classification system for a semiconductor manufacturing process according to one or more embodiments. FIG. 8 illustrates different images of a training domain and a test domain according to one example.

In some embodiments, the image classifier 100 within the image classification system 10 may receive an image from an inspection equipment 200 that generates images for an inspection of semiconductors, perform the test-time adaptation on the image as a single batch unit, and then infer the class of the received image. The image classifier 100 may adapt to a new domain through the test-time adaptation and output the inference result for the images in the batch even if the domains of each image in a single batch are different or the domains of the images are unknown.

When the image classifier 100 is trained based on images from the training domain, the image input from the inspection equipment 200 may be an image from the training domain or an image from the test domain which is different from the training domain. The image classifier 100 according to one or more embodiments may accurately classify the class of the image input to image classifier 100 from the inspection equipment 200 through the test-time adaptation even when the image of the any domain is input during the semiconductor manufacturing process.

Domain change (e.g., the training domain→the test domain) of an image within a batch may occur due to a change in a product generation, an addition of a manufacturing step for the product, etc. Alternatively, the domain change may occur due to a change in a semiconductor design, an addition/change of the inspection equipment 200 and method, etc. When the domain change of the image within the batch occurs during the semiconductor manufacturing process, by performing the large dropout, the weight-space ensemble, and the test-time adaptation based on the entropy of the classification probability distribution, the image classifier 100 may update the first classifier 110 and the second classifier 120 within the image classifier 100, respectively, and accurately determine a class of an image by using the updated first classifier 110 or second classifier 120.

As described above, in an in-fab environment of the manufacturing process, without any additional training for the classification model, the image classifier 100 may update the AI model through the test-time adaptation and determine the class of the image using the updated AI model.

FIG. 9 illustrates a neural network according to one or more embodiments.

Referring to FIG. 9, the neural network 900 may include an input layer 910, a hidden layer portion 920, and an output layer 930. Each of the input layer 910, the hidden layer portion 920, and the output layer 930 may include a respective set of nodes, and strengths of connections between nodes may correspond to weight values. This may be referred to as connection weight. The set of nodes included in each of the input layer 910, the hidden layer portion 920, and the output layer 930 may be fully connected to each other, or less than fully connected. In some embodiments, the number of parameters (weight values and bias values) may be equal to the number of connections within the neural network 900.

The input layer 910 may include a set of input nodes x₁ to xᵢ, and the number of input nodes x₁ to xᵢ may correspond to the number of independent input variables. For training of the neural network 900, a training dataset may be input to the input layer 910, and if a test dataset is input to the input layer 910 of the trained neural network 900, an inference result may be output from the output layer 930 of the trained neural network 900.

The hidden layer portion 920 may be disposed between the input layer 910 and the output layer 930, and may include one or more hidden layers 920₁ to 920ₙ.

The output layer 930 may include at least one output node or y₁ to yⱼ output nodes. An activation function may be used in the hidden layer portion 920 and the output layer 930. In some embodiments, the neural network 900 may be learned by adjusting weight values of hidden nodes included in the hidden layer portion 920.

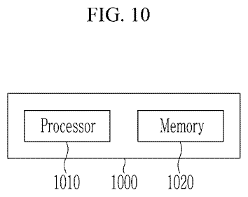

FIG. 10 illustrates an image classifier according to one or more embodiments.

The image classifier may be implemented as a computer system. Referring to FIG. 10, the computer system 1000 includes a processor 1010 and a memory 1020 (the processor 1010 is representative of any single processor or any combination of processors, e.g., a CPU, a GPU, an accelerator, etc.). The memory 1020 may be connected to the processor 1010 to store various information for driving the processor 1010 or instructions configured to cause the processor 1010 to perform a process, method, etc., described above.

The processor 1010 may implement a function, a process, or a method proposed in the embodiment. An operation of the computer system 1000 according to some embodiments may be implemented by the processor 1010.

The memory 1020 may be disposed inside or outside the processor, and the memory may be connected to the processor through various known means. The memory may be a volatile or nonvolatile storage medium of various forms, and for example, the memory may include a read-only memory (ROM) or a random access memory (RAM).

Embodiments may be implemented by programs (in the form of source code, executable instructions, etc.) realizing the functions corresponding to the configuration of the embodiments or a recording medium (not a signal per se) recorded with the programs, which may be readily implemented by a person having ordinary skill in the art to which the present disclosure pertains from the description of the foregoing embodiments. That is to say, with the description above, an engineer or the like may readily, for example, formulate source code corresponding to the description, compile the source code into instructions, and the instructions, when executed by the processor 1010 will cause the processor to perform physical operations analogous to the description above. Specifically, the method (e.g., an image preprocessing method or the like) according to some embodiments may be implemented in the form of program instructions that may be executed through various computer means to be recorded on a computer-readable medium. The computer-readable medium may include program instructions, data files, data structures, and the like, independently or in combination thereof. The program instructions recorded on the computer-readable medium may be specially designed and configured for the embodiment, or may be known to those skilled in the art of computer software so as to be used. The computer-readable recording medium may include a hardware device configured to store and execute the program instructions. For example, the computer-readable recording medium may be a hard disk, a magnetic media such as a floppy disk and a magnetic tape, an optical media such as a CD-ROM and a DVD, a magneto-optical media such as a floptical disk, a ROM, a RAM, a flash memory, or the like. The program instructions may include a high-level language code that may be executed by a computer using an interpreter or the like, as well as a machine language code generated by a compiler.

The computing apparatuses, the electronic devices, the processors, the memories, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method performed by a computing device for determining a class of an image, the method comprising:
receiving a first prediction result for the class from a first classifier and a second prediction result for the class from a second classifier;
updating a first artificial intelligence (AI) model of the first classifier based on the first prediction result and the second prediction result; and
inferring the class using the updated first AI model of the first classifier.

2. The method of claim 1, wherein:
the receiving the first prediction result for the class from the first classifier and the second prediction result for the class from the second classifier comprises
updating second parameters of a second AI model of the second classifier using first parameters of the first AI model of the first classifier; and
receiving the second prediction result for the class from the updated second classifier.

3. The method of claim 2, wherein:
the updating second parameters of the second AI model of the second classifier using the first parameters of the first AI model of the first classifier comprises
updating the second parameters of the second AI model with a weight-space ensemble operation performed on the first parameters and the second parameters.

4. The method of claim 3, wherein:
the weight-space ensemble operation comprises calculating an exponential moving average (EMA) of the first parameters and the second parameters.

5. The method of claim 1, wherein:
the receiving the first prediction result for the class from the first classifier and the second prediction result for the class from the second classifier comprises
performing a dropout on a feature vector of the image generated by an encoder in the first AI model; and
generating the first prediction result from the dropped-out feature vector.

6. The method of claim 1, wherein:
the receiving the first prediction result for the class from the first classifier and the second prediction result for the class from the second classifier comprises
performing a dropout on a node or a connection within an encoder in the first AI model; and
extracting a feature vector of the image using the encoder to which the dropout has been applied and generating the first prediction result from the feature vector using the first AI model.

7. The method of claim 1, wherein:
the receiving the first prediction result for the class from the first classifier and the second prediction result for the class from the second classifier comprises
performing a dropout on a weight value matrix of a linear layer in the first AI model; and
generating the first prediction result based on calculation between the weight value matrix to which the dropout has been applied and a feature vector of the image.

8. The method of claim 1, wherein:
the updating the first classifier based on the first prediction result and the second prediction result comprises
calculating an objective function for updating the first AI model based on cross entropy of the first prediction result and the second prediction result.

9. The method of claim 8, wherein:
the objective function is determined based on a weighted sum of information entropy of the first prediction result and a probabilistic distance between the first prediction result and the second prediction result.

10. The method of claim 1, wherein:
the first AI model and a second AI model of the second classifier are pre-trained based on images belonging to domains to which the image does not belong.

11. An apparatus for determining a class of an image, the apparatus comprising:
one or more processors and a memory,
wherein the memory stores instructions configured to cause the one or more processors to perform a process, and the process comprises:
obtaining a first classification probability distribution for the class using a first artificial intelligence (AI) model;
obtaining a second classification probability distribution for the class using a second AI model;
updating the first AI model based on the first classification probability distribution and the second classification probability distribution; and
inferring the class using the updated first AI model.

12. The apparatus of claim 11, wherein:
the obtaining the first classification probability distribution for the class using the first AI model comprises
performing a dropout on a feature vector of the image generated by an encoder in the first AI model; and
obtaining the first classification probability distribution from the dropped-out feature vector.

13. The apparatus of claim 11, wherein:
the obtaining the first classification probability distribution for the class using the first AI model comprises
performing a dropout on nodes or connections within an encoder in the AI model;
extracting a feature vector of the image using the encoder to which the dropout has been applied; and
obtaining the first classification probability distribution from the feature vector.

14. The apparatus of claim 11, wherein:
the obtaining the first classification probability distribution for the class using the first AI model comprises
performing a dropout on a weight value matrix of a linear layer in the first AI model; and
obtaining the first classification probability distribution based on the weight value matrix to which the dropout has been applied and a feature vector of the image.

15. The apparatus of claim 11, wherein:
the obtaining the second classification probability distribution for the class using the second AI model comprises
updating second parameters of the second AI model using first parameters of the first AI model; and
obtaining the second classification probability distribution for the class using the second AI model having the updated second parameters.

16. The apparatus of claim 15, wherein:
the updating the second parameters of the second AI model using first parameters of the first AI model comprises:
determining momentum used to execute an exponential moving average (EMA) based on a difference between the first classification probability distribution and the second classification probability distribution; and
determining the EMA of the first parameters of the first AI model and the second parameters of the second AI model using the momentum.

17. The apparatus of claim 11, wherein:
the updating the first AI model based on the first classification probability distribution and the second classification probability distribution comprises
calculating an objective function for updating the first AI model based on a weighted sum of information entropy of the first classification probability distribution and Kullback-Leibler (KL) divergences of the first classification probability distribution and the second classification probability distribution.

18. The apparatus of claim 11, wherein:
the updating the first AI model based on the first classification probability distribution and the second classification probability distribution comprises
calculating an objective function for updating the first AI model based on a weighted sum of cross entropy between the first classification probability distribution and the second classification probability distribution and divergences of the first classification probability distribution for a vector whose elements are all 1.

19. An image classification system, comprising
an inspection equipment configured to obtain a test image for inspection of semiconductors; and
an image classifier configured to perform a test-time adaptation on one or more AI models and perform inference on the test image to predict a class of the test image.

20. The system of claim 19, wherein:
in the test-time adaptation, the image classifier is further configured to perform a large dropout for a first AI model of the one or more AI models, update second parameters of a second AI model of the one or more AI models using first parameters of the first AI model, and update the first AI model by determining an objective function based on a first classification probability distribution obtained from the first AI model on which the large dropout has been performed and a second classification probability distribution obtained from the updated second AI model.
